(19) United States
(12) Patent Application Publication
(10) Pub. No.: US 2005/0246903 A1
(43) Pub. Date: Nov. 10, 2005

(54) Ergonomic handle for a utility knife

(76) Inventor: Arthur F. Yeager, Kailua, HI (US)

Correspondence Address: OFFICE OF THE STAFF JUDGE ADVOCATE;U.S. ARMY MEDICAL RESEARCH AND MATERIEL COMMAND, ATTN: MCMR-JA (MS. ELIZABETH ARWINE), 504 SCOTT STREET, FORT DETRICK, MD, 21702-5012, US

(21) Appl. No.: 10/841,437

(22) Filed: May 10, 2004

(51) Int. Cl. B26B 1/00

(52) U.S. Cl. 30/329

(57) ABSTRACT

The present invention is directed to an ergonomic handle for a tool such as a utility knife. The handle includes a body having a first end and a second end. The body includes a lever arm attached to the second end of the body and a grip connected to and located perpendicular to the body. The lever arm rests against the back of a user's hand thereby stabilizing the handle during use.

### I. BACKGROUND OF THE INVENTION

1. Field of the Invention

The present invention relates to utility knives. More particularly, the present invention relates to an ergonomically shaped handle for utility knives and other hand-held tools.

2. Discussion of the Related Art

Utility knives are used for a variety of tasks each requiring different levels of force to be transmitted through the cutting blade. Almost all knives used with medium to heavy force are designed to be held with a gross grasp that forms a composite fist. Such a grip allows one to use larger muscle groups in the shoulder and arm rather than the weaker wrist. Unfortunately, the design of a utility knife does not allow the blade to contact a cutting plane without deviating the wrist out of a neutral position. This potentially harmful position is compounded by an uneven mechanical leverage causing disproportionate stress on the muscles used for ulnar deviation.

For most occasional users this is not a problem and they are not at risk of injury. At higher risk are users that must cut regularly throughout the work day. These users must repeatedly deviate their wrist ulnarly which can lead to a painful diagnosis called radial tenosynovitis or De Quervain's Syndrome. This occurs when the synovial sheaths surrounding the thumb's extensor tendons (distal radial forearm) get inflamed from compression and overuse. If untreated, this condition can eventually require surgery with significant rehabilitation time.

To prevent such injury, tool designers have reduced the amount of ulnar deviation required to use a knife. This is evident in a variety of patented designs that incorporate a bend in the knife. Although much improved, these prior art designs maintain the same knife grip used for centuries. Regardless of how much the angle is changed, it is physically impossible to use prior art knives without deviating the wrist and exerting heavy forces to one muscle group.

### II. SUMMARY OF THE INVENTION

The utility knife and handle of the present invention overcome the limitations of the devices as briefly described above, by providing a design that allows a user to maintain a neutral wrist position while using the stronger flexor muscles to exert force. The larger muscles of the forearm can exert more force for longer periods than the muscles used for wrist deviation. The avoidance of ulnar wrist deviation avoids inflammation and pain caused by repeated compression of the synovial sheaths.

An aspect of the present invention is directed to a utility knife including a handle. The handle includes a body having a first end and a second end. The body further includes a lever arm extending from the body, and a grip connected to the body and located perpendicular to the body. The lever typically extends from the second end of the body. At least a portion of the lever arm rests against the back of a user's hand during use of the utility knife thereby stabilizing the utility knife as it is being used. A blade is attached to the first end of the handle body.

Preferably, the lever arm is padded and the grip is in the shape of a rod. In addition, the utility knife may include a safety guard for covering the knife blade when the device is not being used.

Another aspect of the present invention relates to a utility handle including a body having a first end and a second end. A lever arm extends from the second end of the body, and a grip is connected to the body and preferably located perpendicular to the body.

More particularly, the lever arm rests on the back of a user's hand during use of the utility handle thereby stabilizing the handle as it is being used. Preferably, the lever arm is padded and the grip is in the shape of a rod. In addition, the body is preferably comprised of molded plastic, and may include an orifice though which at least one human finger fits. Furthermore, a cutting, grooming, painting, cleaning, writing or gardening element may be connected to the first end of the handle body.

The accompanying figures show illustrative embodiments of the invention from which these and other of the objectives, novel features and advantages will be readily apparent.

### III. BRIEF DESCRIPTION OF THE DRAWINGS

FIG. 1 is a perspective view of a utility knife made in accordance with the present invention.

FIG. 2a is a front view of a lever arm.

FIGS. 2b-2d are side views of a lever arm.

FIGS. 3a-3b are side views of a prior art utility knife during use.

FIG. 3c is a front view of a prior art utility knife during use.

FIG. 4a is a side view of a utility knife made in accordance with the present invention during use.

FIG. 4b is a bottom view of a utility knife made in accordance with the present invention during use.

FIG. 4c is a front view of a utility knife made in accordance with the present invention during use.

FIGS. 5a and 5b are partial side views of a utility knife made in accordance with the present invention during use.

FIG. 6 is a side view of a utility knife made in accordance with the present invention having a serrated blade.

FIGS. 7a-7c are side views of utility knives made in accordance with an alternative embodiment of the present invention.

FIG. 8 is a partial side view of a utility knife guard made in accordance with an alternative embodiment of the present invention.

FIGS. 9a and 9b are side views of utility knives made in accordance with an alternative embodiment of the present invention during use.

FIG. 10 is a side view of a utility knife made in accordance with an alternative embodiment of the present invention.

### IV. DETAILED DESCRIPTION OF THE PREFERRED EMBODIMENTS

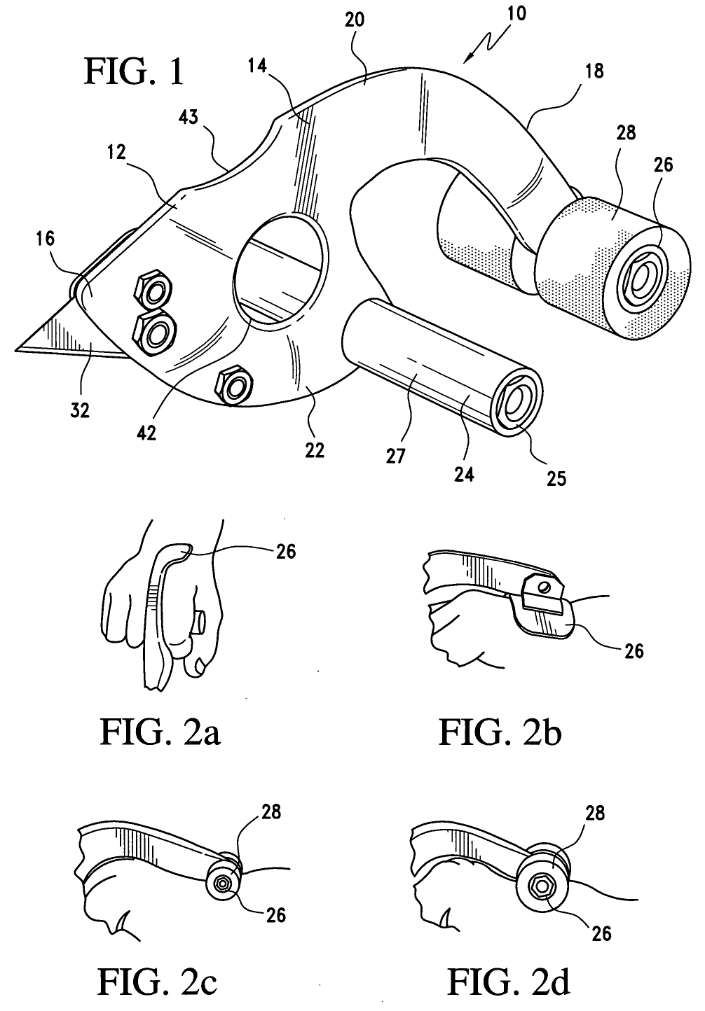

Referring to FIG. 1, shown is a utility knife 10.comprising a handle 12 of the present invention. The handle 12 includes a body 14. The handle body 14 comprises a first end 16, a second end 18, a top portion 20 and a bottom portion 22. The body 14 may be comprised of a variety of materials, including but not limited to non-flexible plastic including high strength molded plastic; wood; and metal including galvanized metal or a lightweight alloy such as aluminum. Preferably, the body is comprised of molded plastic. All or portions of the handle body 14 may be hollow in order to decrease the weight of the handle 12 and utility knife 10.

The handle 12 further includes a grip 24 connected to the body 14 and preferably located substantially perpendicular to the body. The grip 24 forms what is commonly known as a T-grip with the body 14. The grip 24 may be any shape which enables a user to grasp and utilize the handle 12 while maintaining the user's wrist in a neutral position. Preferably, the grip 24 is in the shape of a rod. In addition the grip may be padded to provide comfort to the user. If the grip 24 includes padding, it is desirable for the padding material to be washable. In addition, the grip 24 padding should not be too soft whereby the padding compromises a user's ability to hold the grip 24 in a stable manner. In a preferred embodiment, the grip 24 is connected to the body 14 via a bolt (not shown) which passes through an orifice in the body. A nut 25 is attached to the bolt on each side of the body 14, and a tubular member 27 is located over each nut. Preferably, the tubular member 27 is comprised of plastic.

The handle 12 also includes a lever arm 26 which is attached to the second end 18 of the body 14. The lever arm 26 naturally rests on the back of a user's hand during use of the handle 12 and/or utility knife 10 and helps to stabilize the utility knife 10 or other device utilizing the handle 12 during operation. In an alternative embodiment, the lever arm 26 may be extended to rest against the user's distal forearm during operation thereby preventing movement of the wrist, i.e. full extension of the wrist. In this configuration, a user can relax most of the flexor forearm and use larger muscle groups that are more proximal to the body. The lever arm 26 may be any shape which enables the arm to provide a stabilizing force to the user's wrist during use of the handle 12 and/or utility knife 10. For example, the lever arm 26 may be generally rectangular in shape as illustrated in FIGS. 2a and 2b, or the lever arm may be in the shape of a rod as shown in FIGS. 1, 2c and 2d. The lever arm 26 is preferably padded to provide comfort to the user. The lever arm pads 28 and optional padding (not shown) on the grip 24 may be comprised of any suitable material, including but not limited to foam, rubber, and silicone. Desirably, the lever arm pads 28 and optional padding on the grip 24 are comprised of silicone. In addition, the thickness of the lever arm pads 28 and padding on the grip 24 are preferably between about 0.125 to about 0.25 inch thick. More preferably, the thickness of the lever arm pads 28 and padding on the grip 24 is approximately 0.125 inch.

The grip 24 and lever arm 26 may be comprised of the same materials as the body 12.

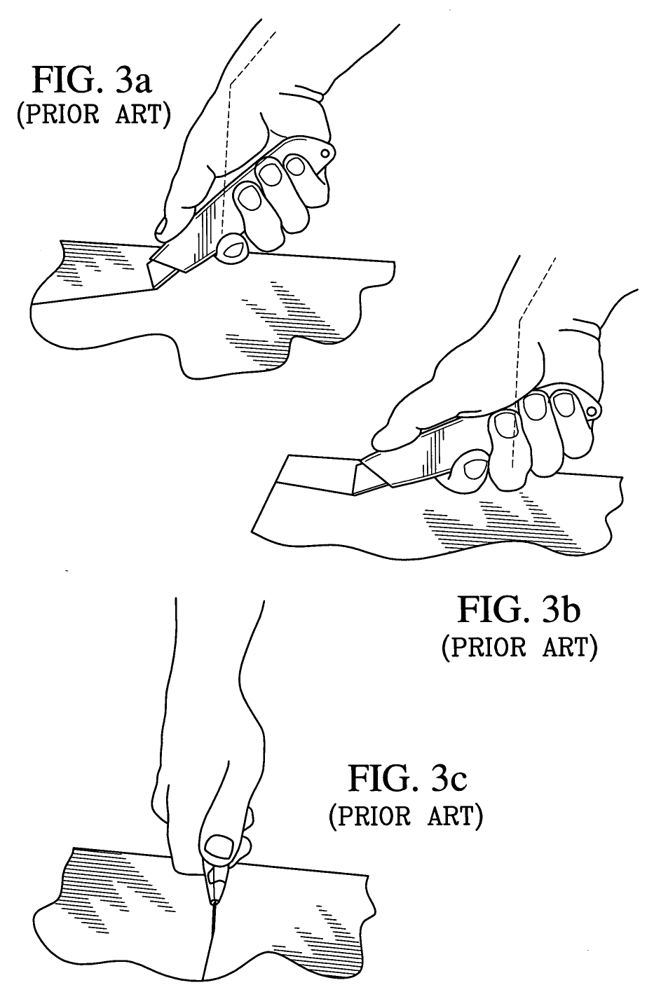

Referring to FIGS. 3a-3c, the disadvantages of using prior art knives and handles are shown. FIGS. 3a and 3b illustrate the ulnar deviation of a user's wrist from a neutral position when using prior art handles with respect to cutting devices. Repeated use in this manner can lead to painful medical conditions.

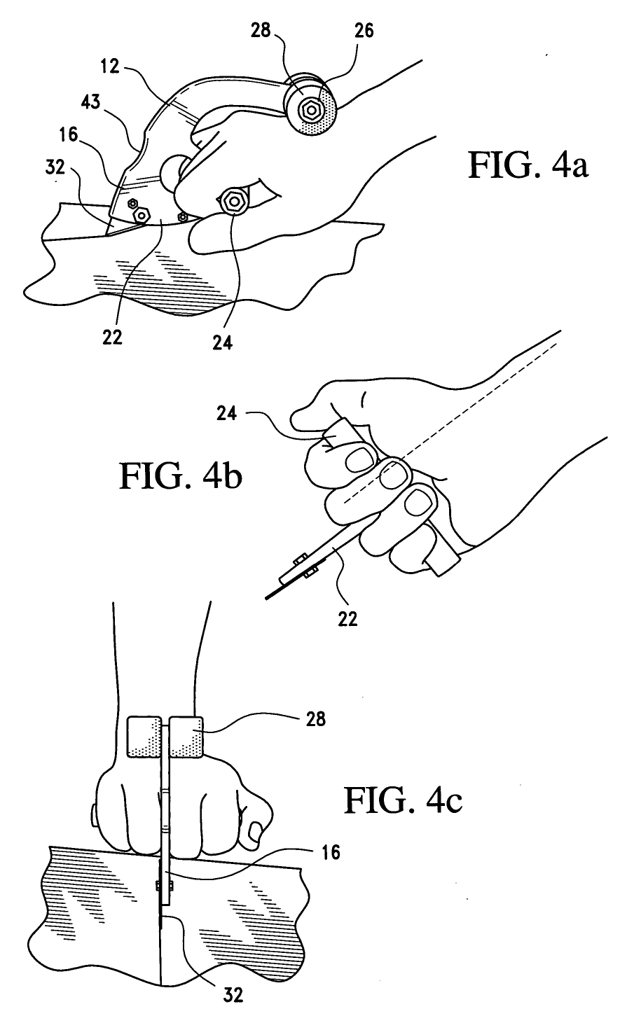

As displayed in FIGS. 4a-4c, a user's wrist is maintained in a neutral position without ulnar deviation during use of the handle 12 and utility knife 10 of the present invention. The gross grasp and neutral wrist position used with the handle 12 of the present invention allows one to use the larger muscle groups in the shoulder or arm as opposed to the weaker wrist. In addition, the design of the handle 12 of the present invention prevents injury caused by uneven forces placed on the wrist during cutting or various tasks.

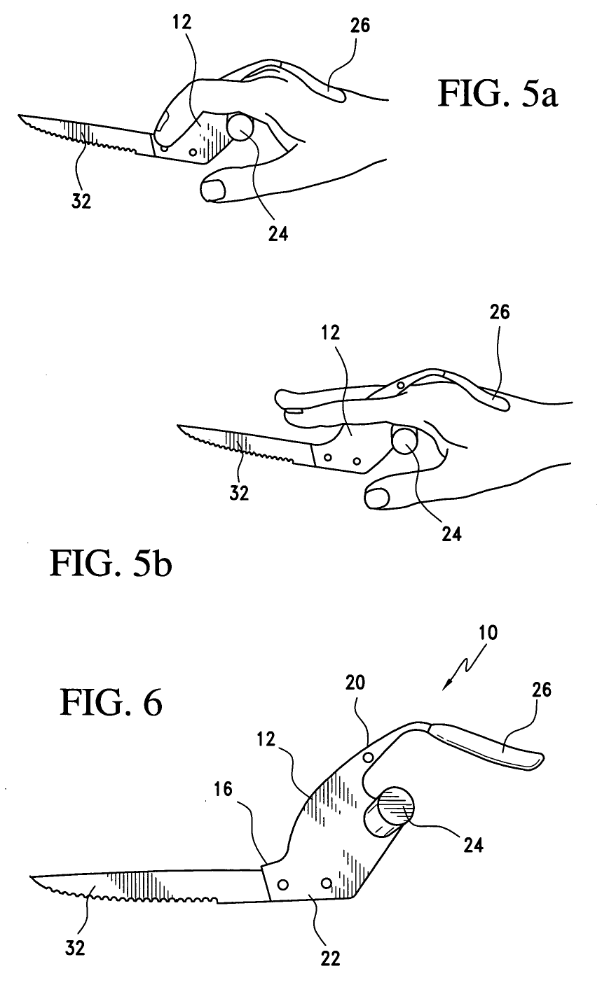

The handle 12 and utility knife 10 of the present invention permit operation without the use of a thumb or a closed hand. This is clearly illustrated in FIGS. 5a and 5b. The present invention is particularly useful for individuals with decreased hand dexterity, strength, and or range of motion. For example, the handle 12 and utility knife 10 of the present invention are particularly beneficial for individuals suffering from arthritis, stroke, cerebral palsy, thumb amputation, nerve damage, amyotrophic lateral sclerosis (ALS or Lou Gehrig's Disease), or multiple sclerosis (MS).

Referring back to FIG. 1, the utility knife 10 of the present invention includes a blade 32 attached the handle body 14. Preferably, the blade 32 is attached to the first end 16 of body 14. The blade 32 may be comprised of a variety of materials including but not limited to stainless steel, carbide and ceramic. Preferably, the blade is comprised of stainless steel. The blade may be any size or shape depending upon the intended use of the utility knife 10. For individuals with decreased hand dexterity and strength, a utility knife 10 including a serrated blade 32 as shown in FIG. 6 may be preferred.

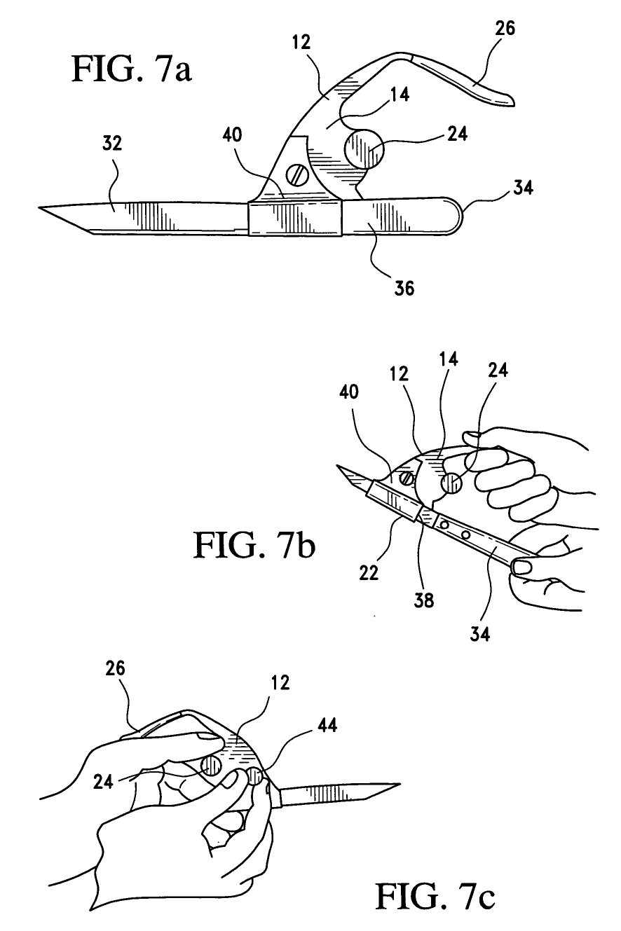

In addition, the blade 32 may be detachable and replaceable with blades of differing sizes or shapes. Alternatively, an entire knife 34 comprising a traditional handle 36, may be detachable and replaceable in the handle 12 as illustrated in FIGS. 7a-7c. The handle 12 may include a slot 38 to receive a knife 34. The slot 38 is preferably configured to receive the traditional handle 36 of the knife 34. The slot 38 may be formed from a top member 40 and the handle body 14. The handle 12 may further comprise a knob 44, whereby rotating the knob causes lateral movement of the top member 40 and/or handle body 14 toward the opposing piece to cause the members to tighten against the knife 34 and hold the knife in place. A portion of the top member 40 may be painted the same color as the traditional knife handle 36 so that the traditional knife handle looks like one continuous piece after it is inserted into the handle 12, as illustrated in FIG. 7a.

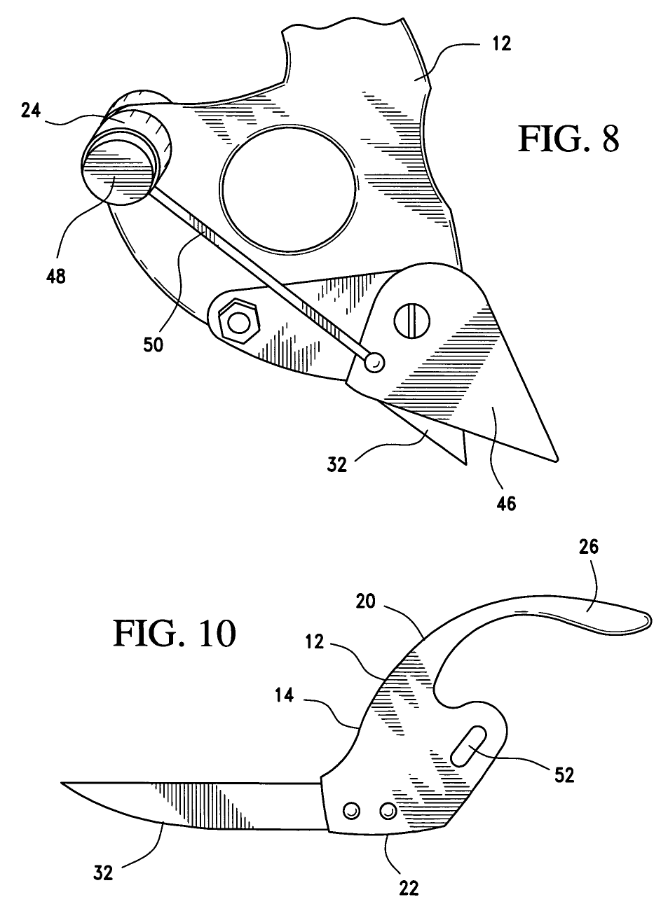

The utility knife 10 of the present invention may also include a safety guard 46 for covering the blade 32 when the utility knife is not being used. This embodiment is shown in FIG. 8. The safety guard 46 may be designed to be removed from the blade 32 manually or by any mechanism known to those having skill in the art. For example, the safety guard 46 may be spring loaded. The utility knife 10 may include a tension spring (not shown) in communication with the safety guard 46, a release actuator 48, and a release arm 50 connected to the release actuator and the safety guard 46. The release actuator 48 may be located on the grip 24. When a user engages the release actuator 48, the release arm 50 moves the safety guard 46 away from the blade 32, thereby exposing the blade. When the blade 32 is no longer in contact with the surface it was cutting, the compressive force of the spring causes the safety guard 46 to automatically move back in place and cover the blade 32. After the safety guard 46 has recovered the blade 32, the release actuator 48 should be engaged in order to expose the blade again for use. The release actuator 48 may be engaged by pressing the actuator. The release actuator 48 may be any actuator known to those having skill in the art including, but not limited to a button, switch or lever. Preferably, the release actuator 48 is a button. The safety guard 46 may be comprised of a variety of materials, including but not limited to plastic, such as clear plastic; plexiglass; aluminum; or thin stainless steel. Preferably, the safety guard 46 is comprised of plastic.

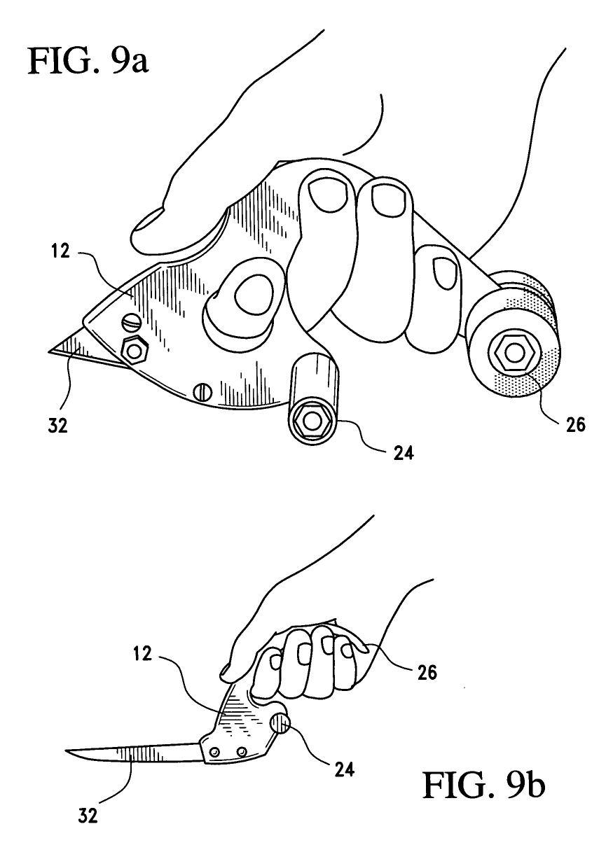

The handle 12 of the present invention may also be constructed to accommodate a traditional grasp. As illustrated in FIGS. 1 and 9a, the handle body 14 may include an orifice 42 through which at least one human finger fits. The top portion 20 of the body 14 may also include a detent 43 for placing a human finger, preferably a thumb, in during use of the handle 12. Alternatively, as shown in FIG. 9b, a user may use a traditional grasp by holding the lever arm 26 and top portion 20 of the handle body 14. The embodiments shown in FIGS. 9a and 9b allow for more fine or detailed work. The use of a traditional grip in these embodiments also illustrates the use of the handle 12 of the present invention as an adaptive device. These embodiments allow a person with decreased grip strength or range of motion to gradually modify and improve their grip to a more difficult grip during rehabilitation. Such a user can transition to a traditional grip so that use of a standard knife or other tool is possible.

In a preferred embodiment of the present invention, the handle 12 is adjustable in order to accommodate hands of different sizes. For example, the grip 24 may be operatively connected to the body 14 via an elongated orifice 52 as illustrated in FIG. 10. The position of the grip 24 may be adjusted by sliding the grip within the orifice 52. During this movement, the grip 24 preferably remains perpendicular to the body 14 and is either slid toward the lever arm 26 to create a smaller distance between the grip and lever arm, or the grip is slid away from the lever arm to create a greater distance between the grip and lever arm. The grip 24 may be adjusted by loosening nuts 25 attached to the bolt (not shown) which is located in orifice 52. When the grip 24 is moved to a desired position relative to the lever arm 26, the nuts 25 are tightened against the bolt and body 14, thereby maintaining the grip 24 in place.

The handle 12 and utility knife 10 of the present invention are particularly useful to individuals who must cut regularly throughout the day. For example, the handle 12 and utility knife 10 of the present invention may be incorporated in or utilized as a glass, carpet, fabric or wood cutter.

The handle 12 of the present invention may be utilized with various utility elements including, but not limited to cutting elements such as blades, knives or razors of different shapes; painting elements such as paint brushes or rollers; cleaning elements including brooms, mops, dusters, plungers or sponges; writing elements such as pens, pencils or markers; eating or cooking elements such as knives, forks, spoons, pizza cutters or bagel cutters; grooming elements including combs, brushes or sponges; or gardening elements including rakes, shovels or hoes and other hand-held tools. The utility element may be connected to the first end 16 of the handle body 14. In addition, the utility element may be detachable and replaceable with a similar or different utility element depending upon the desired use of the handle 12. If any utility element, including those described above, already includes a traditional handle, the handle 12 of the present invention may be designed to be connected to the existing handle. For example, see FIGS. 7a-7c and the accompanying description. In this manner, existing tools with a traditional handle may be modified to have an ergonomic handle.

Specific designs and methods described and shown will suggest themselves to those skilled in the art and may be used without departing from the spirit and scope of the invention. The present invention is not restricted to the particular constructions described and illustrated, but should be constructed to cohere with all modifications that may fall within the scope of the appended claims.

1. A utility knife comprising:
a handle comprising:
a body having a first end and a second end;
a lever arm extending from the body; and
a grip connected to the body and located perpendicular to the body; and
a blade attached to the body.

2. The utility knife of claim 1, wherein the blade is attached to the first end of the body.

3. The utility knife of claim 1, wherein the lever arm is padded.

4. The utility knife of claim 1, wherein at least a portion of the lever arm rests on the back of a user's hand during use of the utility knife.

5. The utility knife of claim 1, wherein the grip is in the shape of a rod.

6. The utility knife of claim 1, wherein the body comprises an orifice through which at least one human finger fits.

7. The utility knife of claim 6, wherein the body comprises a top portion and a body portion, and the top portion of the handle comprises a detent for placing a human finger therein.

8. The utility knife of claim 1, further comprising:
a safety guard for covering the blade when the utility knife is not being used.

9. The utility knife of claim 8, further comprising:
a tension spring in communication with the safety guard;
a release actuator; and
a release arm connected to the release actuator and the safety guard, such that engaging the release actuator causes the release arm to move the safety guard thereby exposing the blade.

10. The utility knife of claim 1, wherein the blade is comprised of stainless steel.

11. The utility knife of claim 1, wherein the blade is replaceable.

12. The utility knife of claim 1, wherein the handle is adjustable to accommodate hands of different sizes.

13. A utility handle comprising:
a body having a first end and a second end;
a lever arm extending from the second end of the body; and
a grip connected to the body and located perpendicular to the body.

14. The utility handle of claim 13, wherein the lever arm is padded.

15. The utility handle of claim 13, wherein the lever arm is configured to rest on the back of a user's hand during use of the handle.

16. The utility handle of claim 13, wherein the grip is in the shape of a rod.

17. The utility handle of claim 13, wherein the body comprises an orifice through which at least one human finger fits.

18. The utility handle of claim 17, wherein the body comprises a top portion and a bottom portion, and the top portion comprises a detent for placing a human finger therein.

19. The utility handle of claim 13, wherein a cutting, grooming, painting, eating, cleaning, writing or gardening element is connected to the body.

20. The utility handle of claim 19, wherein the element is replaceable.

21. The utility handle of claim 13, wherein the handle is adjustable to accommodate hands of different sizes.
